(19) United States
(12) Patent Application Publication
(10) Pub. No.: US 2022/0371452 A1
(43) Pub. Date: Nov. 24, 2022

(54) Electric vehicle with modular battery system

(71) Applicant: Sten Corfitsen, Stockholm (SE)

(72) Inventor: Sten Corfitsen, Stockholm (SE)

(21) Appl. No.: 17/754,600

(22) PCT Filed: Oct. 7, 2020
(86) PCT No.: PCT/SE2020/050956

§ 371 Date: Apr. 7, 2022

(30) Foreign Application Priority Data
Oct. 8, 2019 (SE) 1951147-6

(51) Int. Cl. B60L 50/64; B60L 50/60

(52) U.S. Cl. CPC B60L 50/64; B60L 50/66

(57) ABSTRACT

The invention relates to an electric vehicle (1) comprising an electric motor (2), at least one built-in battery module (3) for powering the motor (2), a control circuit (4) for receiving driver inputs and direct power from the built-in battery module (3) to the motor (2). The vehicle further comprises at least one horizontally placed compartment (5), each compartment (5) configured to receive a single swappable battery module (8), said control circuit (4) configured to enable a swappable battery module (8), when such swappable battery module (8) is provided to the compartment (5), to charge the built in battery module (3) and optionally in addition assist the built-in battery module (3) powering the motor (2).

### TECHNICAL FIELD

The invention relates to an electric vehicle comprising an electric motor, at least one built-in battery module for powering the motor, a control circuit for receiving driver inputs and direct power from the built-in battery module to the motor.

### BACKGROUND

There is previously known different systems for replacement of battery modules for electrical vehicles. Replacing or swapping battery modules can be quicker than having built-in batteries modules that are charged while the driver is waiting. Furthermore, by removing the battery modules to a charging station, the charging conditions can be optimised prolonging the life of the battery modules.

For instance, from EP2231447B1. In such systems, a device under the vehicle is advanced, after the vehicle has been taken up on a ramp similar to those used for inspection pits, and a discharged battery module is replaced for a new one from below. Furthermore, EP 2340951 A2 describes a device for receiving and accommodating a battery module in a vehicle, which battery module is inserted into the vehicle from below and vertically upwards. This device can be used together with a system such as the one described in EP 2231447 B1, above.

It is also known, from SE 1050656 A1, to replace batteries in vehicles by inserting and removing, respectively, battery modules through a vertically arranged door in the vertical side of the vehicle.

Furthermore, in EP2838754 a vehicle equipped with a storage space for a battery module with an opening into the storage space under the vehicle. Here, the vehicle assumes a first and a second predetermined position in relation to first and second battery module transport devices that bring a battery module out from the vehicle and a battery module into the vehicle. The transport devices are installed at least partly above ground and beside the positions, and the batteries are brought along a respective path running from the storage space, under a side beam of the vehicle and up to a respective position above ground and beside the vehicle. A device for automatic battery module replacement and a storage device for use in a vehicle are also described.

The long-time performance of battery modules in electric vehicles are affected by their operating temperature. A good cooling may allow a higher load of the battery module, and lower operating and charging temperatures prolongs the life-length of the battery modules.

### SUMMARY

At least one of the problems mentioned above is to at least some extent met by the electrical vehicle mentioned initially, in which the further comprises at least one horizontally placed compartment, each compartment configured to receive a single swappable battery module, said control circuit configured to enable a swappable battery module, when such swappable battery module is provided to the compartment, to charge the built-in battery module and optionally in addition assist the built-in battery module powering the motor. This design makes it possible to have a more advanced and complex battery design for the built-in battery module while still keeping the cost down since its size can be made small. Since the built-in battery module can be made smaller it is easier to construct an efficient cooling of it. Furthermore, the swappable battery module can be of simpler design without sacrificing its expected life length, since it will mainly be focused on charging the built-in battery module. The swappable battery module/s functions as an extra tank for the vehicle.

In an example, the control circuit is configured to load limit the swappable battery module, when such is present in the compartment. This can be done by limiting the current delivered from the swappable battery module. The load limit reduces the operating temperature of the battery modules and allows for a simpler and lower cost battery module design.

In an example, the load limit is dynamic and dependent of at least one of the following factors:
temperature of the swappable battery module;
temperature of the built-in battery module;
outdoor temperature;
current power level of at least one of the swappable battery module/s;
current power level of the built-in battery module.

In an example, each horizontally placed compartment comprises at least one of the following:
an electric connector for connecting to the swappable battery module;
a guiding means to guide a swappable battery module (8) into desired position in a corresponding compartment;
a pressing means to push and hold the swappable battery module into contact with an electric connector of the compartment, and/or air cooling means;
air cooling means for providing cooling air to the at least one swappable battery module, when such is present in the compartment.

This makes it possible to easy fit the swappable battery module in the compartment and to achieve good connections.

In an example, the compartment height can be variable ranging from a minimum height to a maximum height, in which the electrical connector is placed at a predetermined position in the compartment to allow a larger sized compartment to receive swappable battery module of the same size and smaller. Preferably, a larger compartment includes means for guiding and holding swappable battery module/s of the same size and smaller. Preferably, each height corresponds to a predetermined capacity of the battery, for instance 10, 15, 25 kwh.

In an example, each compartment comprises air cooling means for providing cooling air to the at least one swappable battery module, when such is present in the compartment. Thereby, the swappable battery module can be efficiently cooled. More preferably, each compartment comprises an air inlet and an air outlet for providing cooling air to the interior of a swappable battery module inserted to the compartment.

In an example, a first fan is located at the air outlet and/or a second fan is located at the air inlet, for pushing air into and/or sucking air from the swappable battery module, when such is present in the compartment. This can further improve cooling of the swappable battery modules.

In an example, the at least one compartment is void of means of supplying cooling liquid to the at least one swappable battery module, when such is present in the compartment. This makes the design of the compartment as well as the swappable battery modules less complicated and can reduce costs dramatically. Furthermore, there is no risk for liquid leakage when swapping the battery modules.

In an example, the at least one compartment is in thermal contact with the air under the vehicle. This improves cooling of the swappable battery modules in the compartment.

In one example, the at least one compartment is located at the lower part of the vehicle and between the wheel axles of the vehicle. This improve stability of the vehicle and enables easy access from the side of the vehicle.

In an example, the at least one compartment is mounted below a base plate of the vehicle. This improves cooling of the compartment and makes it possible to add the compartment without affecting the structure of the frame or base plate of the vehicle.

In an example, the at least one compartment is integrated within a base plate of the vehicle. The downward facing side may be in direct contact with the air below the vehicle. This keeps the compartment protected and the ground clearance of the vehicle is affected.

In an example, the at least one compartment is mounted on top of the base plate of the vehicle.

In an example, the vehicle comprises at least two horizontally placed compartment arranged side by side in the same horizontal plane and each having an opening towards one lateral side of the vehicle, and a lid covering the opening that can be opened, such that at least one swappable battery module can be inserted and removed from one side of the vehicle by opening the corresponding lid. This makes it easy to access and swap the swappable battery modules

In an example, each horizontally placed compartment has an electric connector at the opposite side to the opening. This makes it easier to enable good electrical connection.

In an example, the air inlet and/or the air outlet are located at the opposite side to the opening. This makes it easier to enable good air-cooling connection between the swappable battery module and the vehicle.

In an example, the lid is arranged to press the swappable battery module, when such is provided to the compartment, towards the opposite side to the opening to provide a pressing connection with the electric connector and/or the air inlet and/or the air outlet. This make it easier to get good electrical connection and good air-cooling connections.

In an example, the compartment and the control circuit are configured to receive and handle at least one swappable battery module, each having a capacity of 10-100 kWh, and a total capacity of 20-150 kWh, preferably a total capacity of 30-100 kWh. This provide a good source of energy to charge the built-in battery enabling long distance driving.

In an example, the electric vehicle has two compartments such that they can hold up to two swappable battery modules, one in each compartment, and the control circuit being configured to handle swappable battery modules which preferably each having a capacity of 10-75 kWh, more preferably 15-50 kWh. This provide a good source of energy to charge the built-in battery enabling long distance driving.

In an example, the width of the compartment is in the range of 600-1000 mm, preferably 700-900 mm, the lateral depth 1000-1400 mm, preferably 1100-1300 mm, and the height 50-200 mm, preferably 80-150 mm. This enables a size of the swappable battery modules that can be easily handled by a swapping station.

In an example, the vehicle comprising at least two built-in battery modules, a first built-in battery module and second built-in battery module, wherein the control circuit is configured to direct at least one of the built-in battery modules to powering the motor, and to facilitate charging of the other built-in battery module from at least one swappable battery module, when such swappable battery module is provided to the compartment, the control circuit determining how and when to charge respective built-in battery module and which at least one built-in battery module that should power the motor at a given time. This enables, one built-in battery to be charged in a controlled manner and keeping the temperature down, since it is not both being charged and operating at the same time.

Preferably, the control circuit determines which built-in battery module to power the motor and which to charge based on at least one of the following parameters:

a) temperature of respective built in battery module,
b) level of charging of respective built in battery module.

Thereby, the strain on the built-in battery modules can be kept at a minimum.

Preferably, in a coworking operation mode the control circuit directs both the first and the second built in battery modules to power the motor. Thereby, an increased power or acceleration can be enabled when needed.

In an example, the built-in battery module/s has a total capacity of 2.5-20 kWh, preferably 5-15 kWh.

In an example, the electric vehicle has a single built-in battery module having a capacity of 5-15 kWh, preferably not more than 10 kWh.

In an example, the electric vehicle has two built-in battery modules, each have a capacity of 2.5-7.5 kWh, preferably not more than 5 kWh. This provides a sufficient total capacity of the built-in battery modules

Optionally, the built-in battery module/s is liquid cooled. This enables good cooling of the built-in battery module/s.

Preferably, the electric vehicle is a car.

### BRIEF DESCRIPTION OF FIGURES

FIG. 1 is a schematic view of an electric vehicle showing the placement of a swappable battery compartment according to one embodiment,

FIG. 2 is a schematic view of an electric vehicle showing the placement of a swappable battery compartment according to another embodiment,

FIG. 3 is a schematic view of an electric vehicle having a single built-in battery and two compartments for corresponding swappable batteries, and

FIG. 4 is a schematic view of an electric vehicle having two built-in batteries and two compartments for corresponding swappable batteries.

### DETAILED DESCRIPTION

The invention will now be further explained by the following non limiting examples.

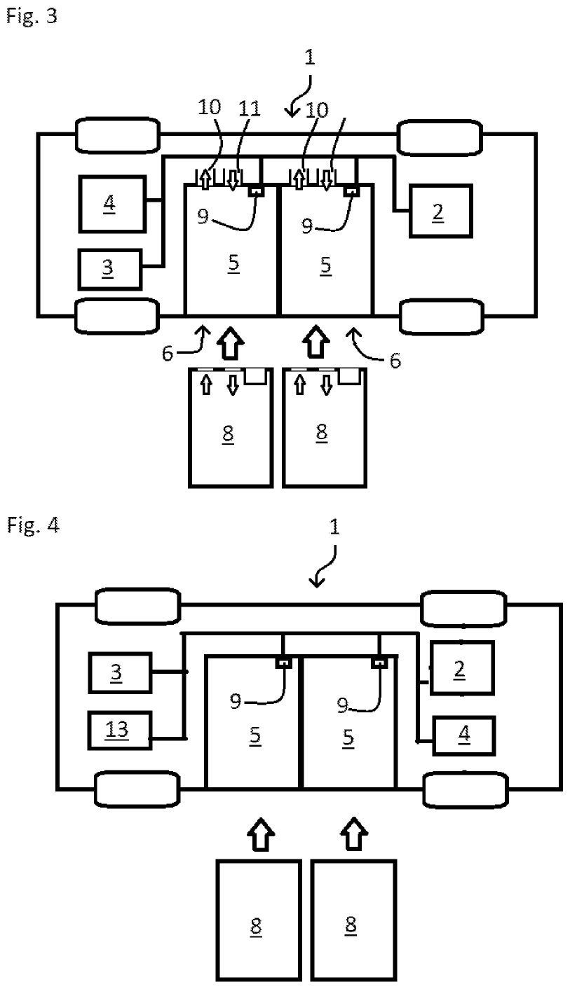

FIGS. 1, 2 and 3 disclose an electric vehicle 1 comprising an electric motor 2, a first built-in battery module 3 for powering the motor 2, a control circuit 4 for receiving driver inputs and direct power from the first built-in battery module 3 to the motor 2.

The electric vehicle 1 further comprises at least one horizontally placed compartment 5, each compartment 5 is configured to receive a single swappable battery module 8. The number of compartments 5 are here shown as two but there may be one up to three compartments 5. The swappable battery modules 8 can be provided to the compartments 5 through automatic swapping such as e.g. described in SE1050656 A1 and EP2838754.

The control circuit 4 configured to enable a swappable battery module 8, when such swappable battery module 8 is provided to the compartment 5, to charge the built-in battery module 3 and optionally in addition to assist the built-in battery module 3 powering the motor 2.

The control circuit 4 is further configured to load limit the swappable battery module 8, when such is present in the compartment 5.

The load limit may be dynamic and dependent of at least one of the following factors:
temperature of the swappable battery module 8;
temperature of the built-in battery module 3;
outdoor temperature;
current power level of at least one of the swappable battery module/s 8;
current power level of the built-in battery module 3.

The compartment 5 height may variable ranging from a minimum height to a maximum height, in which the electrical connector 9 as well as optional air cooling supply means 10, 11 is placed at a predetermined position in the compartment 5 to allow a larger sized compartment 5 to receive swappable battery module 8 of the same size and smaller. Preferably, a larger compartment 5 includes means for guiding and holding swappable battery module/s 8 of the same size and smaller.

The compartment/s 5 is located at the lower part of the vehicle 1 and between the wheel axles of the vehicle.

Each compartment 5 comprises air cooling means 10, 11 for providing cooling air to the swappable battery module 8, when such is present in the compartment 5. The air cooling means 10, 11 shown includes an air inlet 10 and an air outlet 11 in each compartment.

A first fan (not shown) may be located at the air outlet 11 for providing air to a corresponding air inlet of the swappable battery 8. A second fan (not shown) may be located at the air inlet 10, for sucking air from a corresponding air outlet of the swappable battery module 8.

To enable a simple design of the swappable battery 8 and its connection in the compartment 5, it is preferred that the swappable battery 8 is not liquid cooled. However, one or more sides of the compartment 5 may optionally be liquid cooled.

Cooling of the swappable battery can be improved by allowing the compartment 5 to be in thermal contact with the air under the vehicle 1.

According to the embodiment of FIG. 1 the compartment 5 is mounted within a base plate of the vehicle, the downward facing side arranged to be in direct contact with the air below the vehicle.

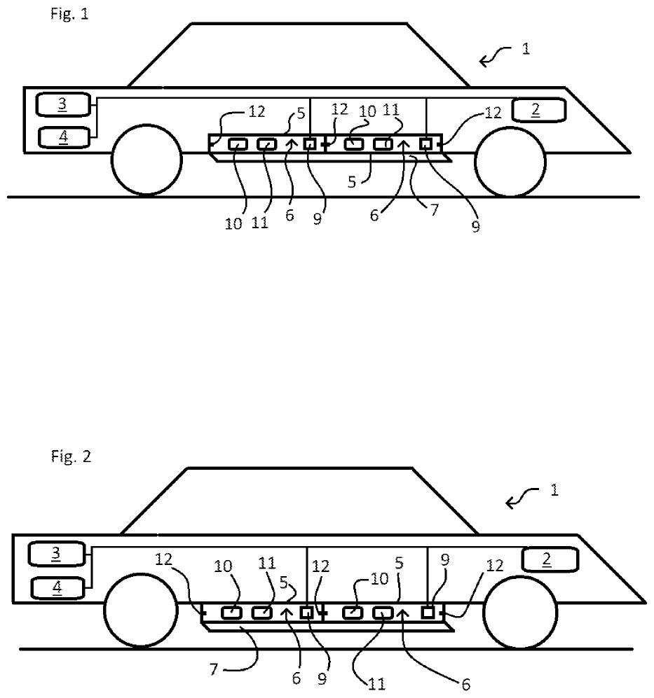

According to the embodiment of FIG. 2 the compartment/s 5 is mounted below a base plate of the vehicle. Exposing the compartment/s 5 to air below the vehicle.

The vehicle shown comprises two horizontally placed compartment 5 arranged side by side in the same horizontal plane and each having an opening 6 towards one lateral side of the vehicle 1, and a lid 7 covering the opening that can be opened and closed. Thereby the swappable battery module 8 can be inserted and removed from one side of the vehicle by opening the corresponding lid 7.

Each horizontally placed compartment 5 has an electric connector 9 at the opposite side to the opening 6. The air inlet 10 and the air outlet 11 are also located at the opposite side to the opening 6.

The lid 7 can be arranged to press the swappable battery 8, when such is provided to the compartment 5, towards the opposite side to the opening 6 to provide a pressing connection with the electric connector 9 and/or the air inlet 10 and/or the air outlet 11.

Each horizontally placed compartment 5 may further comprise a guiding means 12 to guide a swappable battery module 8 into desired position in a corresponding compartment 5.

The compartment 5 and the control circuit 4 are configured to receive and handle at least one swappable battery module 8, one per compartment 5, that each have a capacity of 10-100 kWh, and a total capacity of 20-150 kWh, preferably a total capacity of 30-100 kWh.

In the shown embodiment, the electric vehicle 1 has two compartments 5 such that they can hold up to two swappable battery modules 8, one in each compartment 5. When using two compartments, the control circuit 4 is preferably being configured to handle swappable battery modules 8 that each have a capacity of 10-75 kWh, more preferably 15-50 kWh. The dimensions of the compartments 5, when they are two, are preferably as follows: a) width of the compartment 5 is in the range of 600-1000 mm, preferably 700-900 mm, b) the lateral depth is in the range of 1000-1400 mm, preferably 1100-1300 mm, and c) the height is in the range of 50-200 mm, preferably 80-150 mm.

According to an example shown in FIG. 4, the electric vehicle 1 further comprising a second built-in battery module 13 in addition to the first built-in battery module 3. Here, the control circuit 4 is configured to direct at least one of the built-in battery modules 3, 13 to powering the motor 2, and to facilitate charging of the other built-in battery module 3, 13 from at least one swappable battery module 8, when such swappable battery module 8 is provided to the compartment 5. The control circuit 4 determining how and when to charge respective built-in battery module 3, 13 and which of built-in battery modules 3, 13 that should power the motor 2 at a given time.

In the example shown in FIG. 4, the control circuit 4 determines which built-in battery module 3, 13 to power the motor 2 and which to be charge by a swappable battery 8 based on at least one of the following parameters:

a) temperature of respective built in battery module 3, 13,
b) level of charging of respective built in battery module 3, 13.

In the example of FIG. 4, in a coworking operation mode the control circuit 4 directs both the first and the second built in battery modules 3, 13 to power the motor 2. This can be done when extra power is required.

The built-in battery module/s has a total capacity of 2.5-20 kWh, and is in the example shown in FIG. 1-3 a single built-in battery module 3, and the in the example shown in FIG. 4 two built-in battery modules 3, 13.

The built-in battery module 3, 13 and the swappable battery modules 8 could each be made of a single battery or a pack of batteries.

The built-in battery module 3, 13, is preferably built-in such way that it can be replaced in a normal workshop procedure.

Optionally, the built-in battery module/s 3, 13 is liquid cooled. This enables good cooling of the built-in battery module/s.

1. An electric vehicle comprising an electric motor, at least one built-in battery module for powering the motor, a control circuit for receiving driver inputs and directing power from the built-in battery module to the motor, wherein the vehicle further comprises at least one horizontally placed compartment configured to receive a single swappable battery module the control circuit being configured to enable a swappable battery module, when the swappable battery module is present in the at least one compartment, to charge the built-in battery module and optionally assist the built-in battery module powering the motor.

2. The electric vehicle according to claim 1, wherein the control circuit is configured to load limit the swappable battery module, when the swappable battery module is present in the compartment.

3. The electric vehicle according to claim 2, wherein the load limit is dynamic and dependent of at least one of the following factors:
a temperature of the swappable battery module;
a temperature of the built-in battery module;
an outdoor temperature;
a current power level of at least one of the swappable battery modules; and
a current power level of the built-in battery module.

4. The electric vehicle according to claim 1, wherein each horizontally placed compartment comprises at least one of the following:
an electric connector for connecting to the swappable battery module;
a guiding means for guiding a swappable battery module into a desired position in the compartment;
air cooling means for providing cooling air to the swappable battery module, when the swappable battery module is present in the compartment.
a pressing means for pushing and holding the swappable battery module into contact with one or more of the electric connector and the air cooling means.

5. The electric vehicle according to claim 4, wherein a compartment height is variable, and wherein the electrical connector is placed at a predetermined position in the compartment to allow a compartment to receive a swappable battery module having a same or smaller size as the compartment.

6. The electric vehicle according to claim 5, wherein a compartment includes means for guiding and holding one or more swappable battery modules having a same or smaller size as the compartment.

7. The electric vehicle according to claim 1, wherein each compartment comprises an air inlet and an air outlet for providing cooling air to the interior of a swappable battery module inserted into the compartment.

8. The electric vehicle according to claim 1, wherein the at least one compartment is void of means of supplying cooling liquid to the at least one swappable battery module inserted into the compartment.

9. The electric vehicle according to claim 1, wherein the at least one compartment is in thermal contact with the air under the vehicle.

10. The electric vehicle according to claim 1, wherein the at least one compartment is located at the lower part of the vehicle and between the wheel axles of the vehicle.

11. The electric vehicle according to claim 1, wherein the at least one compartment is mounted in one of the following positions:
below a base plate of the vehicle;
integrated with the base plate of the vehicle; and
on top of the base plate of the vehicle.

12. The electric vehicle according to claim 1, wherein the vehicle comprises at least two horizontally placed compartments arranged side by side in the same horizontal plane, and wherein each compartment has an opening towards a lateral side of the vehicle, and a movable lid covering the opening, allowing insertion and removal of at least one swappable battery module removed from a side of the vehicle by opening the corresponding lid.

13. The electric vehicle according to claim 12, wherein each horizontally placed compartment has an electric connector at the opposite side of the opening.

14. The electric vehicle according to claim 12, wherein at least one of the air inlet and the air outlet is located at the opposite side of the opening.

15. The electric vehicle according to claim 13, wherein the lid is arranged to push a swappable battery inserted in the compartment towards the opposite side of the opening to provide a pressing connection with at least one of the electric connector, the air inlet, and the air outlet.

16. (canceled)

17. (canceled)

18. (canceled)

19. The electric vehicle according to claim 1, comprising a first built-in battery module and a second built-in battery module, wherein the control circuit is configured to direct at least one built-in battery module to power the motor, and to facilitate charging of the other built-in battery module from at least one swappable battery module, when the swappable battery module is inserted in the compartment, wherein the control circuit is operable to determine how and when to charge a built-in battery module and what built-in battery module should power the motor at a given time.

20. The electric vehicle according to claim 19, wherein the control circuit is operable to determine what built-in battery module should power the motor and what built-in battery module to charge based on at least one of the following parameters:
a) a temperature of a built-in battery module, and
b) a level of charging of a built-in battery module.

21. The electric vehicle according to claim 19, wherein in a coworking operation mode the control circuit directs both the first and the second built-in battery modules to power the motor.

22. (canceled)

23. (canceled)

24. (canceled)

25. The electric vehicle according to claim 1, wherein the built-in battery module is liquid cooled.

26. The electric vehicle according to claim 7, further comprising one or more of: a first fan located at the air outlet, and a second fan located at the air inlet, for extracting air from and pushing air into, respectively, the swappable battery module in the compartment.
